(19) United States
(12) Patent Application Publication
(10) Pub. No.: US 2008/0024920 A1
(43) Pub. Date: Jan. 31, 2008

(54) Head gimbal assembly with micro-actuator and manufacturing method thereof, and disk drive unit with the same

(75) Inventor: MingGao Yao, DongGuan (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., Hong Kong (CN)

(21) Appl. No.: 11/494,523

(22) Filed: Jul. 28, 2006

(51) Int. Cl. G11B 5/60

(52) U.S. Cl. 360/234.3

(57) ABSTRACT

A HGA of the invention includes a slider, a micro-actuator with PZT elements, and a suspension for supporting the slider and the micro-actuator. The slider has a leading edge, a trailing edge opposite to the leading edge, an air-bearing surface connecting the leading edge and the trailing edge, and a slider mounting surface opposite to the air-bearing surface. The micro-actuator is positioned between the slider and the suspension with the PZT elements facing the slider mounting surface. The slider further has a transition surface connecting the leading edge and the slider mounting surface. The transition surface is recessed into the slider, so the transition surface is not easy to hit the PZT elements, thus the shock performance of the HGA is improved. The invention also discloses a manufacturing method of the HGA and a disk drive unit having such an HGA.

### FIELD OF THE INVENTION

The present invention relates to an information recording disk drive unit, and more particularly to a head gimbal assembly (HGA) with micro-actuator and its manufacturing method.

### BACKGROUND OF THE INVENTION

Disk drives are information storage devices that use magnetic media to store data and a movable read/write head positioned over the magnetic media to selectively read data from and write data to the magnetic media.

Consumers are constantly desiring greater storage capacity for such disk drive devices, as well as faster and more accurate reading and writing operations. Thus, disk drive manufacturers have continued to develop higher capacity disk drives by, for example, increasing the density of the information tracks on the disks by using a narrower track width and/or a narrower track pitch. However, each increase in track density requires that the disk drive device have a corresponding increase in the positional control of the read/write head in order to enable quick and accurate reading and writing operations using for the higher density disks. As track density increases, it becomes more and more difficult using known technology to quickly and accurately position the read/write head over the desired information tracks on the storage media. Thus, disk drive manufacturers are constantly seeking ways to improve the positional control of the read/write head in order to take advantage of the continual increases in track density.

One approach that has been effectively used by disk drive manufacturers to improve the positional control of read/write heads for higher density disks is to employ a secondary actuator, known as a micro-actuator, which works in conjunction with a primary actuator to enable quick and accurate positional control for the read/write head. Disk drives that incorporate a micro-actuator are known as dual-stage actuator systems.

Various dual-stage actuator systems have been developed in the past for the purpose of increasing the speed and fine tuning the position of the read/write head over the desired tracks on high density storage media. Such dual-stage actuator systems typically include a primary voice-coil motor (VCM) actuator and a secondary micro-actuator, such as a PZT micro-actuator. The VCM actuator is controlled by a servo control system that rotates the actuator arm that supports the read/write head to position the read/write head over the desired information track on the storage media. The PZT micro-actuator is used in conjunction with the VCM actuator for the purpose of increasing the positioning speed and fine tuning the exact position of the read/write head over the desired track. Thus, the VCM actuator makes larger adjustments to the position of the read/write head, while the PZT micro-actuator makes smaller adjustments that fine tune the position of the read/write head relative to the storage media. In conjunction, the VCM actuator and the PZT micro-actuator enable information to be efficiently and accurately written to and read from high density storage media.

One known type of micro-actuator incorporates PZT elements for causing fine positional adjustments of the read/write element. Such PZT micro-actuators include associated electronics that are operable to excite the PZT elements on the micro-actuator to selectively cause expansion or contraction thereof. The PZT micro-actuator is configured such that expansion or contraction of the PZT elements causes movement of the micro-actuator which, in turn, causes movement of the read/write head. This movement is used to make faster and finer adjustments to the position of the read/write head, as compared with a disk drive unit that uses only a VCM actuator. Such exemplary PZT elements have been disclosed in various published documents, for example, US Patent Pub. No. 20030168935, entitled “Piezoelectric Driving Device”.

FIGS. 1a-1b illustrate a conventional disk drive unit and show a magnetic disk 101 mounted on a spindle motor 102 for spinning the disk 101. A voice coil motor arm 104 carries a HGA 100 that includes a slider 103, incorporating a read/write element. A voice-coil motor (VCM) 109 is provided for controlling the motion of the motor arm 104 and, in turn, controlling the slider 103 to move from track to track across the surface of the disk 101, thereby enabling the read/write head to read data from or write data to the disk 101. In operation, a lift force is generated by the aerodynamic interaction between the slider 103 and the spinning magnetic disk 101. The lift force is opposed by equal and opposite spring forces applied by a suspension of the HGA 100 such that a predetermined flying height above the surface of the spinning disk 101 is maintained over a full radial stroke of the motor arm 104.

Referring to FIGS. 2a-2c, the HGA 100 includes the slider 103, a pair of PZT elements 135 for fine positional adjustments of the slider 103, and a suspension 180 to support the slider 103 and the PZT elements 135. The suspension 110 comprises a flexure 122, a slider support 121, a flexure support 123, and a load beam 124.

The flexure 122 has a PZT element mounting area 128 and a slider mounting area 107 at an end thereof. The PZT element mounting area 128 forms a plurality of, such as four, electrical pads 110 thereon. Two PZT elements 135 are mounted on the PZT element mounting area 128, which have a plurality of connection pads electrically connecting with the electrical pads 110. The slider mounting area 107 forms a plurality of electrical pads, such as four electrical pads 111 thereon. The slider 103 is mounted on the slider mounting area 107 and has a plurality of connection pads 115 electrically connecting the electrical pads 111. The electrical pads 111 and the connection pads 115 are coupled by electrical connection balls 116 (gold ball bonding or solder ball bonding, GBB or SBB). The flexure 122 further has a plurality of electrical multi-traces 112, one end of which connects with a control system, and the other end of which connects with the electrical pads 110, 111 respectively. Thus the control system can respectively control the slider 103 and the PZT elements 135 through the electrical multi-traces 112.

The slider support 121 is placed on bottom of the slider mounting area 107 to support the slider mounting area 107 and the slider 103 thereon. The slider support 121 is provided with a bump 127 thereon. The bump 127 aims at the center of the slider 103 when the slider is mounted on the slider mounting area. The flexure support 123 is located on bottom of the PZT element mounting area 128 to support the PZT element mounting area 128 and the PZT elements 135 thereon. The slider support 121 and the flexure support 123 are physically connected by the flexure 122. The load beam 124 is provided under the slider support 121 and the flexure support 12 to support both of them. The load beam 124 forms a dimple 125 thereon that works with the bump 127. When the slider 103 is flying on the disk, the dimple 125 supports the bump 127, which keeps the load force from the load beam 124 always being applied to the center of the slider 103 evenly, thus ensuring the slider 103 have a good flying performance, such as a good fly attitude.

The slider 103 has a slider mounting surface 130 and a leading edge 119 adjacent to the slider mounting surface 130. The slider mounting surface 130 is partially mounted on the slider mounting area 107 of the flexure 122 with a parallel gap 113 formed between the slider mounting surface 130 and the PZT elements 135. The parallel gap 113 keeps the flying slider 103 from interfering with the PZT elements 135. With reference to FIG. 2b, when a voltage is applied to the PZT elements 135, one of the PZT elements 135 may contract as shown by arrow D, but the other one may expand as shown by arrow E. This will generate a rotation torque that cause the slider mounting area 107 and the slider support 121 to rotate in the arrowed direction C and, in turn, make the slider 103 move. Thus a fine positional adjustment for the slider 103 is realized by the PZT elements 135.

Since the slider 103 is partially supported by the dimple 125 of the load beam 124, when a vertical vibration or a shock event happens, especially when a tilt drop shock happens, the slider 103 is easy to rotate against the dimple 125. Referring to FIG. 2d, the slider 103 rotates against the dimple 125 of the load beam 124 toward the PZT elements 135. Because the leading edge 119 and the slider mounting surface 130 of conventional slider 103 intersect at sharpened edge, the sharpened edge of the slider 103 is easy to hit the PZT elements 135 during the rotation and cause the PZT elements 135 damage, such as crack or broken. This will affect the work performance of the PZT elements 135.

Hence, it is desired to provide an improved HGA with micro-actuator and its manufacturing method, and a disk drive unit with such HGA to solve the above-mentioned problems and achieve a good performance.

### SUMMARY OF THE INVENTION

Accordingly, a main feature of the present invention is to provide a HGA with micro-actuator which is capable of keeping a slider of the HGA from damaging the micro-actuator or reducing the damage during a vibration or a shock event, thereby achieving a good shock performance.

Another feature of the present invention is to provide a method of manufacturing a HGA with micro-actuator to improve shock performance thereof the HGA.

A further feature of the present invention is to provide a disk drive unit with a good shock performance.

To achieve the above-mentioned features, a HGA for a disk drive unit comprises a slider, a micro-actuator with PZT elements, and a suspension for supporting the slider and the micro-actuator. The slider has a leading edge, a trailing edge opposite to the leading edge, an air-bearing surface connecting the leading edge and the trailing edge, and a slider mounting surface opposite to the air-bearing surface. The micro-actuator is positioned between the slider and the suspension with the PZT elements facing the slider mounting surface. The slider further has a transition surface connecting the leading edge with the slider mounting surface. The transition surface intersects the leading edge at a first cross line and intersects the slider mounting surface at a second cross line. The distance between the first cross line and the air-bearing surface is less than that between the slider mounting surface and the air-bearing surface, and the distance between the second cross line and the trailing edge is less than that between the leading edge and the trailing edge.

According to embodiments of the present invention, the transition surface is a step-like surface, an inclined surface, or a curved surface. Preferably, the transition surface is an arc surface.

According to the present invention, a disk drive unit comprises a HGA, a drive arm to connect with the HGA, a disk, and a spindle motor to spin the disk. The HGA comprises a slider, a micro-actuator with PZT elements, and a suspension for supporting the slider and the micro-actuator. The slider has a leading edge, a trailing edge opposite to the leading edge, an air-bearing surface connecting the leading edge and the trailing edge, and a slider mounting surface opposite to the air-bearing surface. The micro-actuator is positioned between the slider and the suspension with the PZT elements facing the slider mounting surface. The slider further has a transition surface connecting the leading edge with the slider mounting surface. The transition surface intersects the leading edge at a first cross line and intersects the slider mounting surface at a second cross line. The distance between the first cross line and the air-bearing surface is less than that between the slider mounting surface and the air-bearing surface, and the distance between the second cross line and the trailing edge is less than that between the leading edge and the trailing edge.

A method of manufacturing a HGA according to the present invention comprises the steps of: 1) providing a row bar constituted by a group of juxtaposed sliders, each slider having a leading edge, a trailing edge opposite to the leading edge, an air-bearing surface connecting the leading edge and the trailing edge, and a slider mounting surface opposite to the air-bearing surface; 2) machining the row bar on intersection of the leading edge and the slider mounting surface to form a transition surface; 3) cutting the row bar into individual sliders; 4) providing a suspension and a micro-actuator having PZT elements; and 5) assembling one of the sliders, the micro-actuator and the suspension with the micro-actuator positioned between the slider and the suspension, and the PZT elements facing the slider mounting surface.

According to an embodiment of the present invention, the transition surface is machined by lapping.

Since the leading edge and the slider mounting surface of the slider intersect at the transition surface without a sharpened edge, the slider is kept from damaging the PZT elements during a vibration or a shock event, or the damage can be reduced, thus to improve the shock performance of the disk drive unit. In addition, the transition surface is preferably an arc surface so as to ensure the damage from the slider considerably reduced as a violent shock happens.

The present invention will be apparent to those skilled in the art by reading the following description of several particular embodiments thereof with reference to the attached drawings, in which:

### BRIEF DESCRIPTION OF THE DRAWINGS

FIG. 1a is a perspective view of a conventional disk drive unit;

FIG. 1b is a partial perspective view of the disk drive unit shown in FIG. 1a;

FIG. 2a is an exploded, perspective view of a conventional HGA;

FIG. 2b is a partial top plan view of the assembled HGA shown in FIG. 2a;

FIG. 2c is a partial, side elevational view of the assembled HGA shown in FIG. 2a;

FIG. 2d is a diagrammatic view illustrating a leading edge of a slider shown in FIG. 2c hitting PZT elements during a vibration or shock event;

FIG. 3a is an assembled, perspective view of a first embodiment of a HGA according to the present invention;

FIG. 3b is a partial, enlarged perspective view of the HGA of FIG. 3a;

FIG. 3c is an exploded, perspective view of the HGA of FIG. 3a;

FIG. 3d is a partial side elevational view of the HGA of FIG. 3a, showing the relationship between the positions of a transition surface of the slider and the PZT elements when a vibration or shock happens;

FIG. 3e is a plan view of the slider shown in FIG. 3d seen from a slider mounting surface of the slider;

FIG. 4 is a perspective view of a second embodiment of a slider according to the present invention;

FIG. 5a illustrates a testing system for testing the shock performance of the disk drive unit;

FIG. 5b shows a testing data acquired by testing the conventional disk drive unit and a disk drive unit incorporating the present slider respectively by the testing system shown in FIG. 5b;

FIG. 6 is a flow chart of manufacturing the HGA according to the present invention;

FIGS. 7a-7b are views illustrating steps of manufacturing the slider according to an embodiment of the present invention;

FIG. 8a-8b are views illustrating steps of manufacturing the slider according to another embodiment of the present invention; and

FIG. 9 is a perspective view of a disk drive unit according to the present invention.

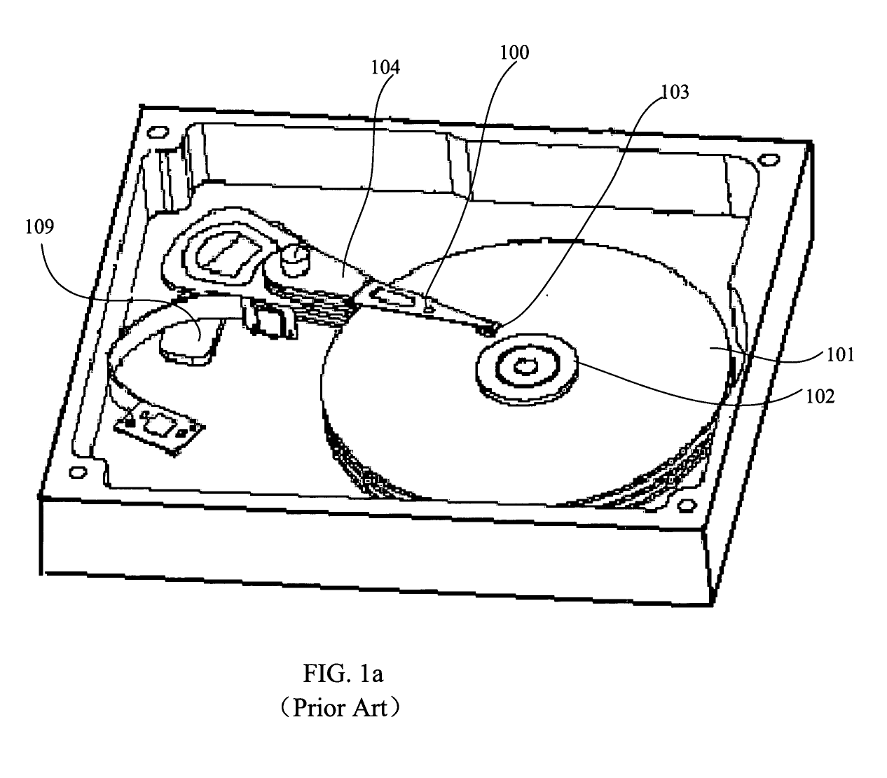

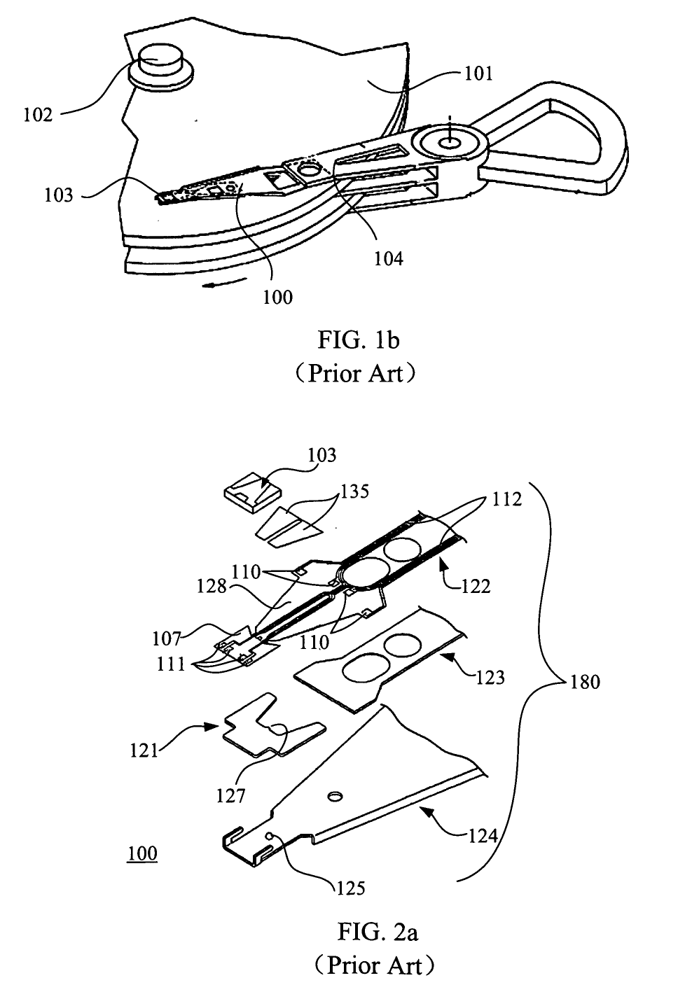

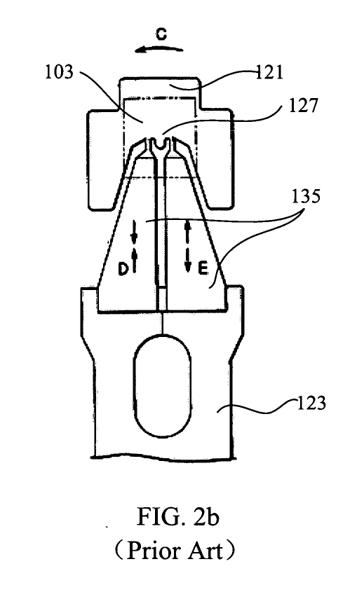

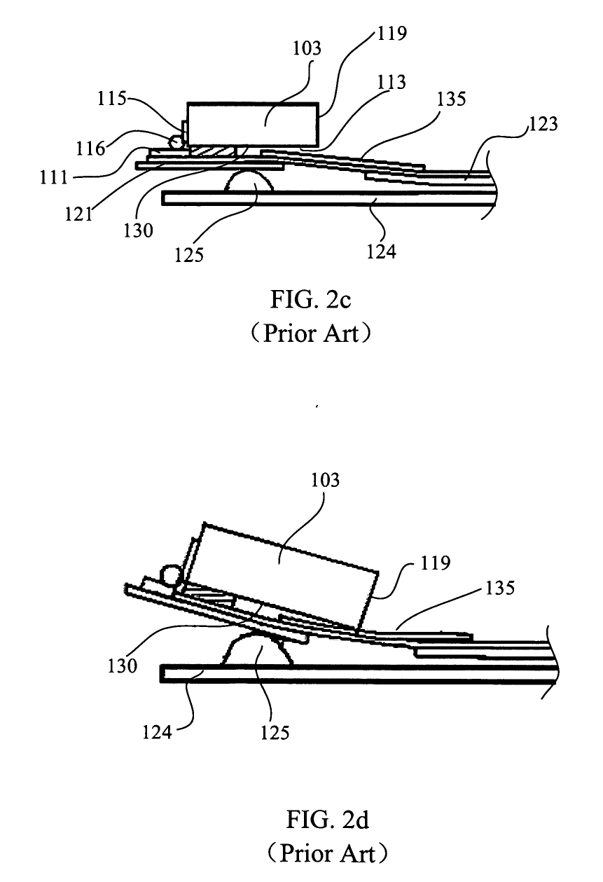

### DETAILED DESCRIPTION OF THE PREFERRED EMBODIMENTS

Various preferred embodiments of the instant invention will now be described with reference to the figures, wherein like reference numerals designate similar parts throughout the various views. As indicated above, the instant invention is designed to provide an improved slider for a head gimbal assembly. The slider has a leading edge, a trailing edge opposite to the leading edge, an air-bearing surface connecting the leading edge and the trailing edge, and a slider mounting surface opposite to the air-bearing surface. A sharpened edge intersected by the leading edge and the slider mounting surface is machined to form a transition surface, such as a step-like surface recessed into the slider, or a smooth curved transition surface. The transition surface intersects the leading edge at a first cross line, and the distance between the first cross line and the air-bearing surface is less than that between the slider mounting surface and the air-bearing surface. The transition surface intersects the slider mounting surface at a second cross line, and the distance between the second cross line and the trailing edge is less than that between the leading edge and the trailing edge. Compared with a conventional slider with sharpened edge, the transition surface of the slider of the invention spaces the PZT elements farther, so the transition surface of the slider of the invention is not easy to hit the PZT elements when a vibration or shock happens. Even if the transition surface hits the PZT elements, the damage to the PZT elements from the transition surface is far less than that from the sharpened edge of the conventional slider because the contact area between the transition surface and the PZT elements of the invention becomes larger than that of the prior art.

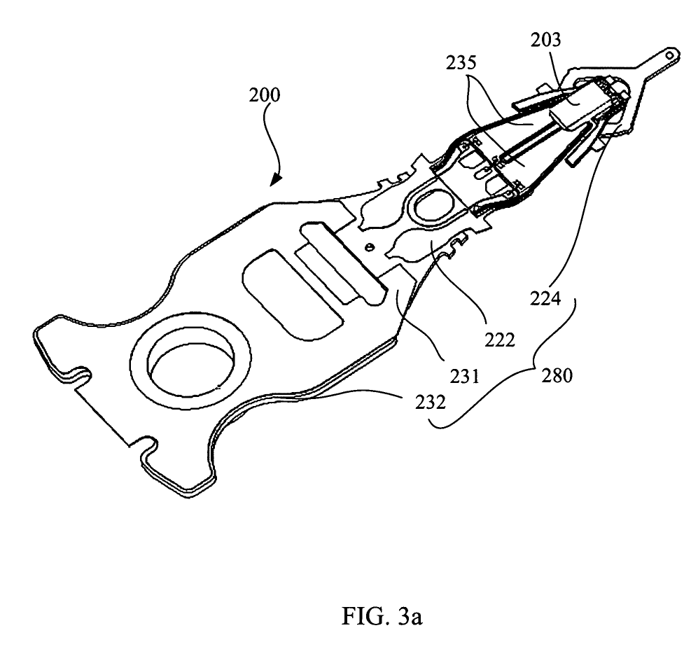

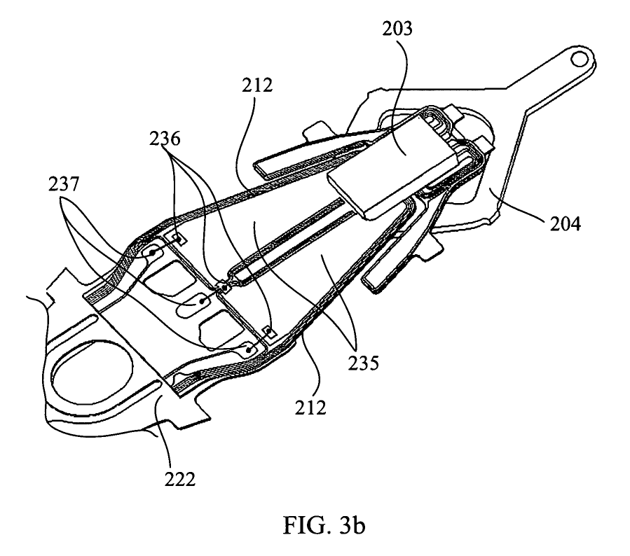

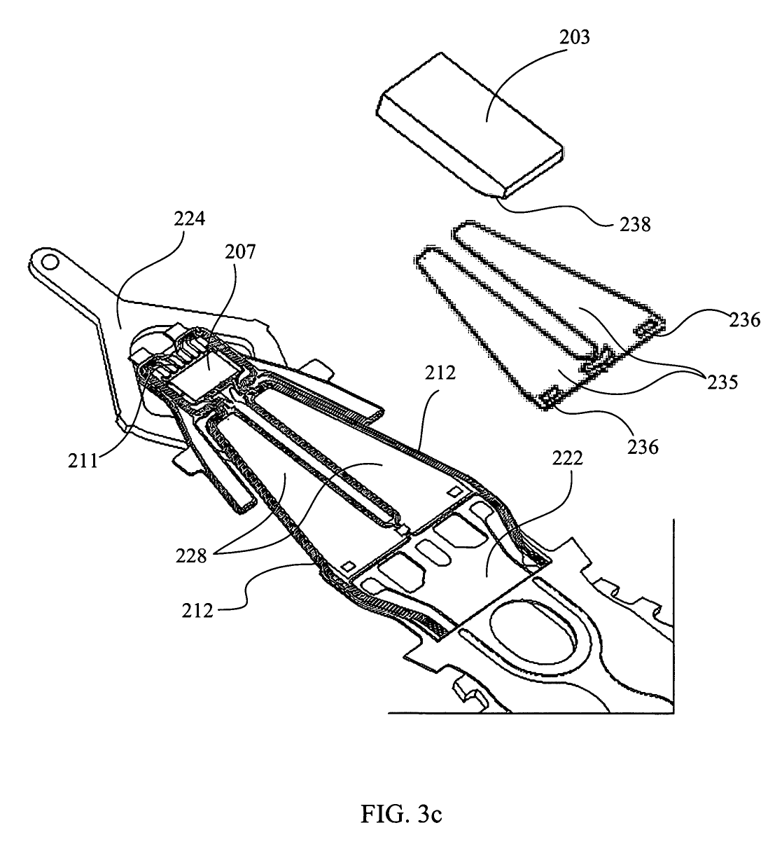

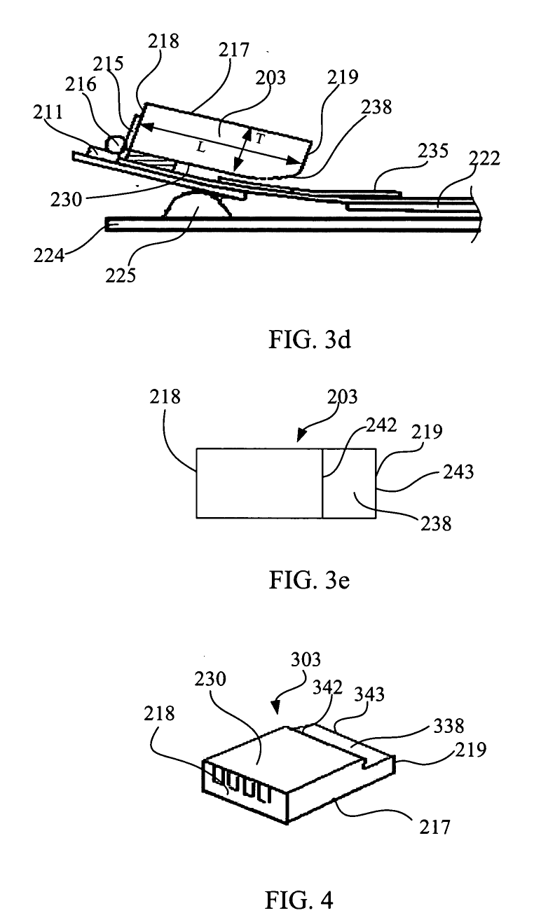

FIGS. 3a-3c illustrate a head gimbal assembly (HGA) 200 incorporating the slider according to an exemplary embodiment of the present invention. The HGA 200 comprises a suspension 280 and a slider 203 held on the suspension 280. The suspension 280 includes a base plate 232, a hinge 231, a flexure 222, and a load beam 224, which are assembled together.

The flexure 222 has a PZT element mounting area 228, and a slider mounting area 207 at an end thereof. A plurality of electrical pads, such as four electrical pads 237 are formed on the PZT element mounting area 228. Two PZT elements 235 are mounted on the PZT element mounting area 228, each of which has a plurality of connection pads 236 to electrically connect with the electrical pads 237. A plurality of electrical pads, such as four electrical pads 211 are formed on the slider mounting area 207. The slider 203 is mounted on the slider mounting area 207, which has a plurality of connection pads 215 (shown in FIG. 3d ) to electrically connect with the electrical pads 211. The electrical pads 211 and the connection pads 215 are connected by electrical connection balls (gold ball bonding or solder ball bonding, GBB or SBB) 216 (shown in FIG. 3d ).

In the embodiment, the flexure 222 further comprises a plurality of multi-traces 212, one end of which connect with a control system (not shown), and the other end of which connect with the electrical pads 237, 211, respectively. Thus the control system can respectively control the slider 203 and the PZT elements 235 through the multi-traces 212. In addition, a dimple 225 is formed on the load beam 224. When the slider 203 is flying above the disk, the dimple 225 supports a center area of the bottom of the slider 203, which keeps the load force from the load beam 224 always being applied to the center of the slider 103 evenly, thus ensuring the slider 103 have a good flying performance.

Referring to FIGS. 3c-3e, the slider 203 has a leading edge 219, a trailing edge 218 opposite to the leading edge 219, an air-bearing surface 217 connecting the leading edge 219 with the trailing edge 218, and a slider mounting surface 230 opposite to the air-bearing surface 217. The trailing edge 218 has a read/write element and the above-mentioned connection pads 215. The slider mounting surface 230 is partially mounted on the slider mounting area 207 of the flexure 222. The slider 203 further comprises a transition surface 238 which connects the leading edge 219 with the slider mounting surface 230. The transition surface 238 intersects the leading edge 219 at a first cross line 243 and intersects the slider mounting surface 230 at a second cross line 242. The distance between the first cross line 243 and the air-bearing surface 217 is less than that between the slider mounting surface 230 and the air-bearing surface 217, that is, the width T of the slider 203. The distance between the second cross line 242 and the trailing edge 218 is less than that between the leading edge 219 and the trailing edge 218, that is, the length L of the slider 203. In the present embodiment, the transition surface 238 is a smooth curved surface to connect the slider mounting surface 230 with the leading edge 219.

Referring to FIG. 3d, a parallel gap is formed between the slider mounting surface 230 and the PZT elements 235. The parallel gap keeps the flying slider 203 from interfering with the PZT elements 235. When the disk drive unit is suffered from vibration or shock, the slider 203 rotates against the dimple 225 toward the trailing edge 218 or the leading edge 219. When the slider 203 rotates toward the leading edge 219, the leading edge 219 gradually approaches the PZT elements 235. Since the transition surface 238 is recessed into the slider 203, the transition surface 238 is not easy to hit the PZT elements 235. Even if the transition surface 238 hits the PZT elements 235, the damage to the PZT elements 235 from the transition surface 238 is far less than that from the sharpened edge of the conventional slider because the contact area between the transition surface 238 and the PZT elements 235 is far larger.

FIG. 4 illustrates a slider 303 according to a second embodiment of the invention. The slider 303 has a step-like transition surface 338. Similar to the curved transition surface 238 of the slider 203, the step-like transition surface 338 intersects the slider mounting surface 230 at a second cross line 342, and the distance between the second cross line 342 and the trailing edge 218 is less than the length of the slider 303. The step-like transition surface 338 intersects the leading edge 219 at a first cross line 343, and the distance between the first cross line 343 and the air-bearing surface 217 is less than the width of the slider 303. The step-like transition surface 338 functions comparably with the curved transition surface 238, and the step-like transition surface 338 is easier to be formed.

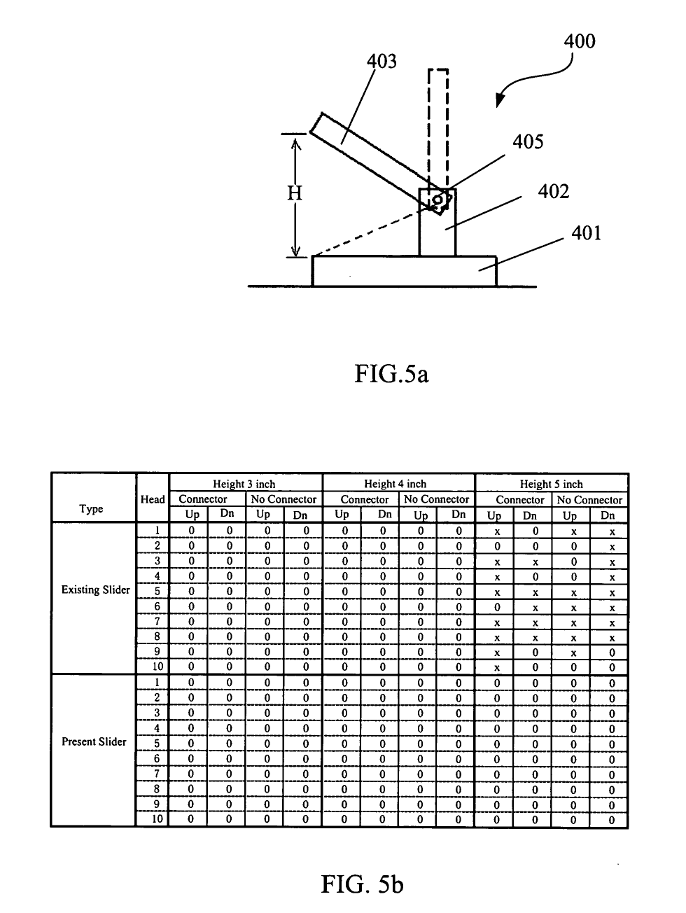

FIG. 5a illustrates a lilt drop testing system 400 (such as a lilt drop testing system) for testing the shock performance of the disk drive unit. As shown in FIG. 5a, the testing system 400 comprises a horizontal bottom plate 401 and a support plate 402 vertically mounted on the bottom plate 401. The support plate 402 has a pivot hinge 405 formed at its top end. During testing the disk drive unit 403, one end of the disk drive unit 403 is pivotally connected with the hinge 405, and the other end is lifted to a height H from the bottom plate 401. The height H is drop height of the disk drive unit 403. In an embodiment, ten groups of conventional disk drive units and ten groups of present disk drive units are respectively tested, the drop height is selectively set to 3 inch, 4 inch, or 5 inch, the drop end of the disk drive unit is selectively set to the connector end or the no connector end, and the disk drive unit is selectively set as facing up or facing down. During every testing, the disk drive unit is freely rotated and drops to the bottom plate 401. After every drop shock after each drop height, the tester checks the PZT elements to see if there are any damage to the disk drive unit. The testing data are listed in FIG. 5b wherein the symbol 0 denotes the disk drive unit past the test, and the symbol X denotes the disk drive unit did not pass the test. It can be seen from FIG. 5b, when the drop height is gradually increased, such as increased to 5 inch, most conventional disk drive units did not pass the test, while all of the present disk drive units past the test. This shows that the present disk drive unit has a better shock performance that the conventional disk drive unit.

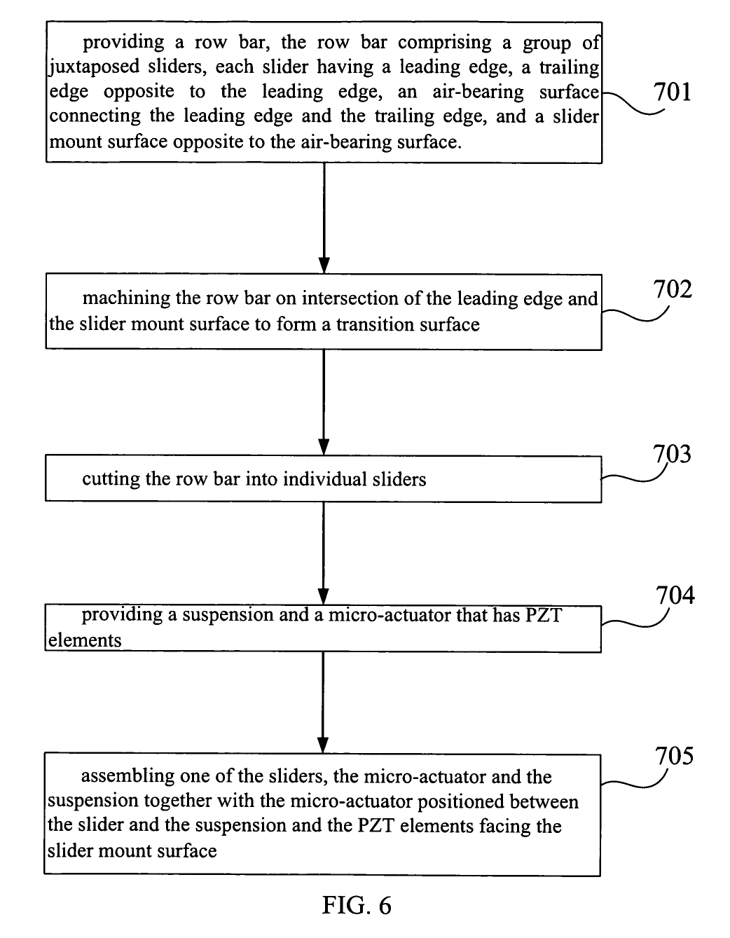

Referring to FIG. 6, a method of manufacturing the HGA according to the present invention comprises the steps of: 1) providing a row bar constituted by a group of juxtaposed sliders, each slider having a leading edge, a trailing edge opposite to the leading edge, an air-bearing surface connecting the leading edge and the trailing edge, and a slider mounting surface opposite to the air-bearing surface (step 701); 2) machining the row bar at intersection of the leading edge and the slider mounting surface to form a transition surface (step 702); 3) cutting the row bar into individual sliders (step 703); 4) providing a suspension and a micro-actuator having PZT elements (step 704); and 5) assembling one of the sliders, the micro-actuator and the suspension together with the micro-actuator positioned between the slider and the suspension, and the PZT elements facing the slider mounting surface (step 705). Preferably, the transition surface is machined by lapping.

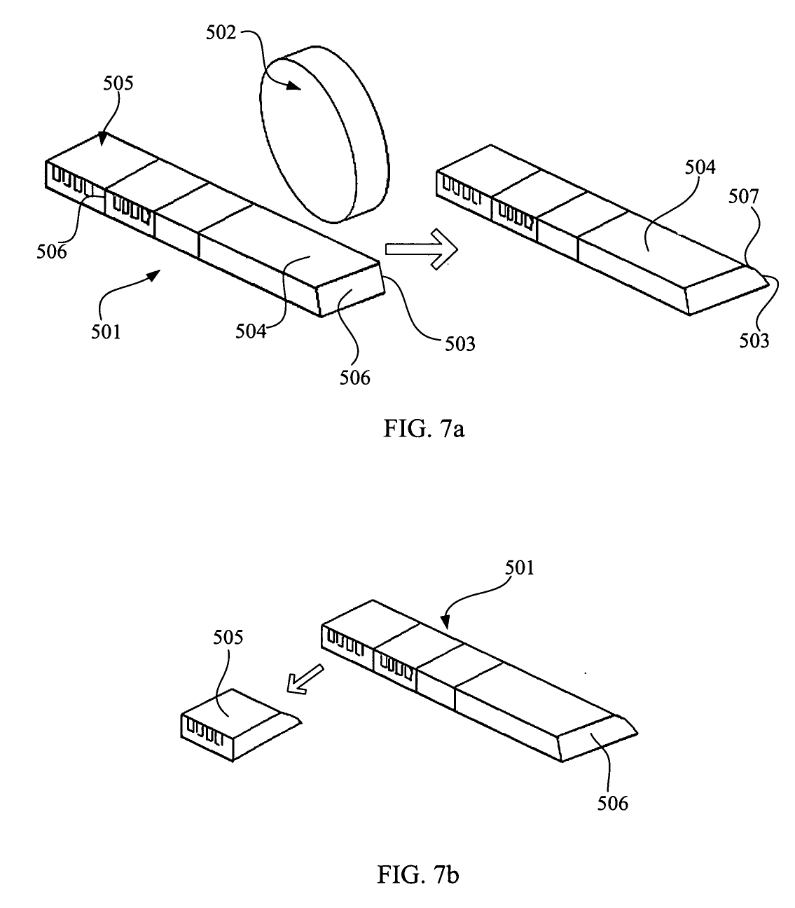

FIGS. 7a-7b illustrate steps of manufacturing the slider according to an embodiment of the present invention. As shown in FIG. 7a, a row bar 501 is constituted by a group of juxtaposed sliders 505. Each slider 505 has a slider mounting surface 504 and a leading edge 503 intersecting with the slider mounting surface 504. Between every two adjacent sliders 505 there is a cutting surface 506. In the present embodiment, a lapping device, such as a lapping wheel with a slap edge 502 is used for lapping the intersection of the slider mounting surface 504 and the leading edge 503 to form a transition surface 507. In the embodiment, the transition surface 507 is an inclined surface. Then, referring to FIG. 7b, the row bar 501 is cut into individual sliders 505 along the cutting surfaces 506 after the transition surface 507 is formed.

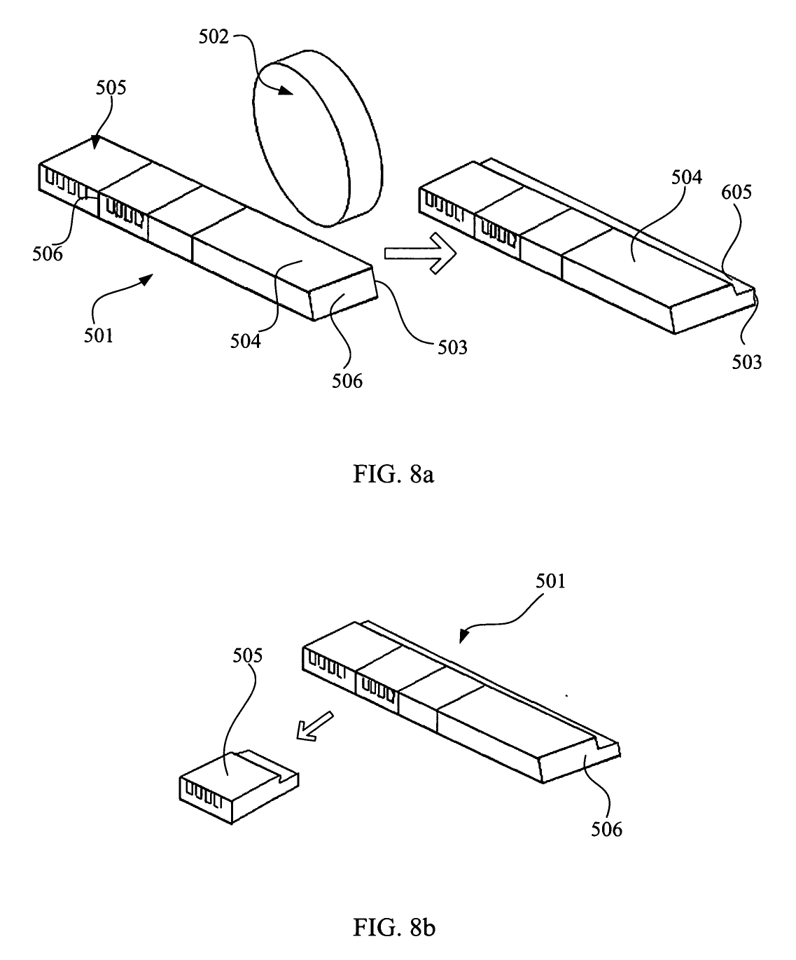

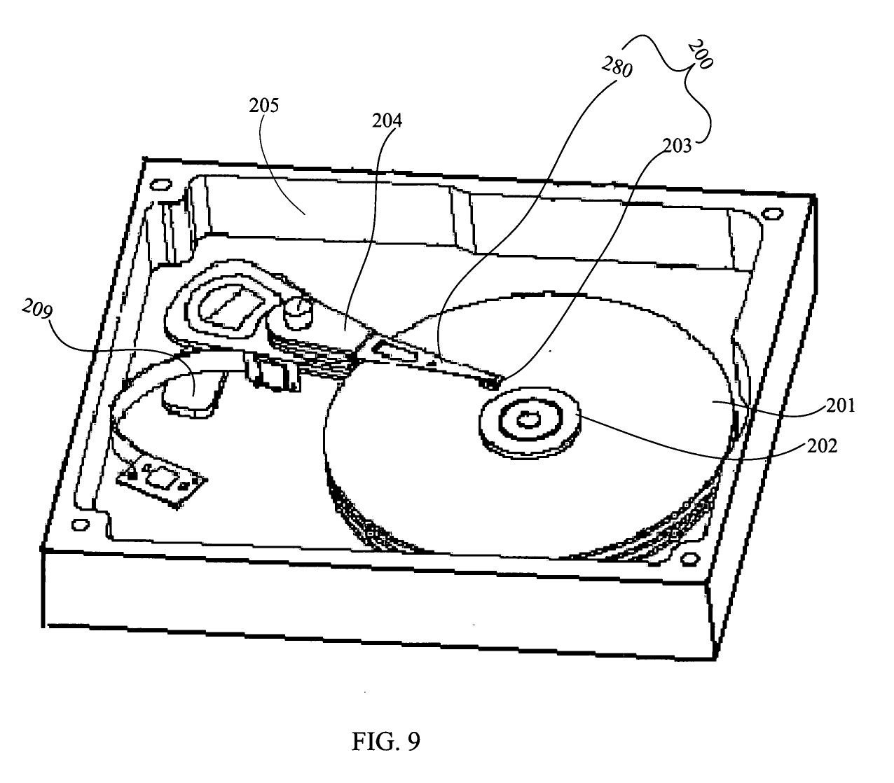

FIGS. 8a-8b illustrate steps of manufacturing the slider according to another embodiment of the present invention which is similar to that shown in FIGS. 7a-7b. The difference is in that the transition surface 605 in the embodiment is lapped into a step-like surface.

Referring to FIG. 9, according to an embodiment of the present invention, a disk drive unit can be attained by assembling a housing 205, a disk 201, a spindle motor 202 for spinning the disk 201, a VCM 209, and a drive arm 204 with the HGA 200 of the present invention. The HGA 200 may include the suspension 280 and the slider 203, 303 or 505 held on the suspension 280. Because the structure and/or assembly process of disk drive unit of the present invention are well known to persons ordinarily skilled in the art, a detailed description of such structure and assembly is omitted herefrom. In addition, any other suitable type disk drive unit can also be applied to the present invention, so long as it has an improved HGA of the present invention.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A head gimbal assembly for a disk drive unit comprising:
a slider, which has a leading edge, a trailing edge opposite to the leading edge, an air-bearing surface connecting the leading edge and the trailing edge, and a slider mounting surface opposite to the air-bearing surface;
a micro-actuator having PZT elements; and
a suspension for supporting the slider and the micro-actuator, the micro-actuator being positioned between the slider and the suspension, and the PZT elements facing to the slider mounting surface; wherein
the slider further has a transition surface connecting the leading edge and the slider mounting surface, the transition surface intersects the leading edge at a first cross line and intersects the slider mounting surface at a second cross line, the distance between the first cross line and the air-bearing surface is less than that between the slider mounting surface and the air-bearing surface, and the distance between the second cross line and the trailing edge is less than that between the leading edge and the trailing edge.

2. The head gimbal assembly as claimed in claim 1, wherein the transition surface is a step-like surface, an inclined surface, or a curved surface.

3. The head gimbal assembly as claimed in claim 1, wherein the transition surface is an arc surface.

4. A disk drive unit comprising:
a head gimbal assembly;
a drive arm to connect with the head gimbal assembly;
a disk; and
a spindle motor to spin the disk; wherein
the head gimbal assembly comprises:
a slider, the slider having a leading edge, a trailing edge opposite to the leading edge, an air-bearing surface connecting the leading edge and the trailing edge, and a slider mounting surface opposite to the air-bearing surface;
a micro-actuator having PZT elements; and
a suspension for supporting the slider and the micro-actuator, the micro-actuator being positioned between the slider and the suspension with the PZT elements facing to the slider mounting surface; wherein
the slider further has a transition surface connecting the leading edge and the slider mounting surface, the transition surface intersects the leading edge at a first cross line and intersects the slider mounting surface at a second cross line, the distance between the first cross line and the air-bearing surface is less than that between the slider mounting surface and the air-bearing surface, and the distance between the second cross line and the trailing edge is less than that between the leading edge and the trailing edge.

5. The disk drive unit as claimed in claim 4, wherein the transition surface is a step-like surface, an inclined surface, or a curved surface.

6. The disk drive unit as claimed in claim 4, wherein the transition surface is an arc surface.

7. A method of manufacturing a head gimbal assembly as claimed in claim 1, which comprising the steps of:
providing a row bar constituted by a group of juxtaposed sliders, each slider having a leading edge, a trailing edge opposite to the leading edge, an air-bearing surface connecting the leading edge and the trailing edge, and a slider mounting surface opposite to the air-bearing surface;
machining the row bar on intersection of the leading edge with the slider mounting surface to form a transition surface;
cutting the row bar into individual sliders;
providing a suspension and a micro-actuator having PZT elements; and
assembling one of the sliders, the micro-actuator and the suspension with the micro-actuator positioned between the slider and the suspension, and the PZT elements facing to the slider mounting surface.

8. The manufacturing method as claimed in claim 7, wherein the transition surface is machined by lapping.

9. The manufacturing method as claimed in claim 7, wherein the transition surface is a step-like surface, an inclined surface, or a curved surface.

10. The manufacturing method as claimed in claim 7, wherein the transition surface is an arc surface.
